(19) United States
(12) Patent Application Publication
(10) Pub. No.: US 2020/0201834 A1
(43) Pub. Date: Jun. 25, 2020

(54) SYSTEMS AND METHODS OF EFFICIENT EXTENSIONS OF RELATIONAL TABLES IN A DATABASE

(71) Applicants: Changqing Ye, Irvine, CA (US); Ping Liang, Newport Coast, CA (US)

(72) Inventors: Changqing Ye, Irvine, CA (US); Ping Liang, Newport Coast, CA (US)

(73) Assignee: Fast River Technologies Inc., Irvine, CA (US)

(21) Appl. No.: 16/228,769

(22) Filed: Dec. 21, 2018

(51) Int. Cl. G06F 16/22; G06F 16/28; G06F 16/2455

(52) U.S. Cl. CPC G06F 16/2282; G06F 16/24554; G06F 16/284

(57) ABSTRACT

This invention discloses methods and systems for extending standard defined domain relational tables in a database to enable the inclusion of storage and exchange of data that do not fit into the standard defined domain data model to support multiple enterprise applications and organizations with diverse application requirements. Each application may dynamically extend the meanings of the standard defined fields by values or by both values and data types or add additional fields in the standard defined domain relational tables. The extensions enable a standard defined domain data model to support a wide range of enterprise applications with diverse requirements and system variability between organizations and reduce the complexity of integration and interoperability.

### FIELD OF INVENTION

This invention relates generally to relational databases, and to methods and systems that enable efficient processing of extension to standard defined data models in a relational database.

### BACKGROUND

In a relational database, relational schemas are created based on generally agreed common data models that can be leveraged by multiple systems and organizations. Sometimes, relational schemas are defined by Standard Defining Organizations (SDO). We refer to predefined relational schemas as standard defined or simply standard. Using standard defined relational schemas reduces the complexity of the integration and interoperability. However, predefined schemas limit the flexibility and often become problematic in many situations because of diversity of systems and application requirements across many organizations, and it also increases the deployment risk because of the unanticipated requirements. One way to overcome this is to have the flexibility of extending standard defined domain schemas, on the fly if needed. This is especially useful in a distributed environment where a standard defined table or field can be extended to meet the requirements of different applications. In a standard defined relational schema with the flexibility of extension, a standard defined table can add one or more new fields as needed to store new contents; one application can interpret or translate one or more defined fields differently from other applications; one application can introduce one or more additional fields and make them available to other applications. One prior art solution is to include all the extensions in the domain schema, but the consequence of this solution is that the domain tables grow very large and become cumbersome and inefficient to use and manage. Moreover, it is no different from a standard defined schema in nature, it is just one with many extra fields and tables that may only be used infrequently or not used at all, and it does not allow new extensions that were not anticipated to be added when the need arises. The present invention provides systems and methods that solve this difficulty in an efficient and effective manner.

### SUMMARY OF INVENTION

This invention discloses methods and systems for extending standard defined domain relational tables in a database to enable the inclusion of storage and exchange of data that do not fit into the standard defined domain data model to support multiple enterprise applications and organizations with diverse application requirements. Each application may dynamically extend the meanings of the standard defined fields by values or by both values and data types or add additional fields in the standard defined relational tables. Each defined table can add one or more additional fields that are not part of the default defined fields, and each defined field of a table can be altered to have a different meaning. Each application can read, write, store and exchange legal extensions. The new meaning of an extension to a standard defined field or an additional field is defined by an Extension Definition (ED) which is stored in an Extension Definition Table (EDT). Each extension refers to the extension definition entry in the EDT using a reference or a uniform resource locator (URL). An extension is created by one application and is available to other applications. The extensions enable a standard defined data model to support a wide range of applications with diverse requirements and system variability between organizations and reduce the complexity of integration and interoperability.

In this invention, the unit of change to a defined domain relational table is called an extension. An extension includes value element, data type element and the meaning of the change (Extension Definition). A relational database system comprising one or more standard defined domain relational tables interacts with a plurality of enterprise applications. Each application can read an extension from the database, write a new extension into the database, and exchange an extension with other application through a network. An extension created by one application can be made available and understandable to other applications using the database. The applications and database can run on any environment such as cloud, on-premise, centralized or distributed. The communication between applications and database can go through any network using any interface. The present invention provides novel methods and systems for extending any standard defined domain relational tables in a relational database system such as redefining the meaning of a defined field column of a table or adding a new field column to a defined table, and on the fly if needed.

In one embodiment, three types of tables are created for any standard defined domain data models, referred to as First Table, Second Table and Third Table. A standard domain data model is hierarchically composed of a primary object, one or more primitive data type fields, one or more child objects, one or more complex data type fields; a child object is composed of one or more primitive data type fields, one or more child objects, one or more complex data type fields. A table has a table name or table Id that uniquely identifies a table in a database system. A field has a field name or field Id that uniquely identifies a field in a table. Table name and table Id or field name and field Id are used interchangeably. The hierarchical data models can be implemented in a schema of hierarchical First Tables: build a First Table for primary object; build one or more First Tables for one or more child objects; build one or more First Tables for complex data types. The primitive data types are supported by an underlying database system. Each primary First Table has a primary key column that is used to uniquely identify a row in a database system, and one or more fields. Each child or complex type First Table has a primary key column, a foreign key column which is used to uniquely point to a row of its parent object First Table, and one or more fields. A foreign key value is a primary key value of a row of its parent First Table. A complex type First Table is a specific First Table. Comparing with a child First Table, besides a primary key column, a foreign key column, and one or more fields, a complex type First Table also includes a PATH column which is used for identifying which First Table owns a row of this complex type First Table. Primary First Table and multiple child First Tables utilizes the same a complex type First Table for storing the values of complex data types.

An extension for a First Tables is stored in a Second Table. The Second Table consists of columns including a primary key column, a foreign key column, a PATH column, a URL column, and a VALUE column, wherein a primary key is designated to uniquely identify rows; a foreign key is designated to uniquely identify a row of one or more First Tables; a PATH represents which First Table is extended or which Field of which First Table is extended; Combing a PATH with a foreign key, an extension is associated with a row of a First Table in which a defined field is extended or an additional field is added. A URL points to a row of a Third Table that stores Extension Definitions. Extension Definitions can be prepopulated into the Third Table or populated through a user interface. An Extension Definition can be persistent along with a domain message when the domain message is persistent. All First Tables utilize a single Second Table which can be partitioned by its foreign key column to improve query efficiency and performance. The Second Table can be indexed by a composite key of primary key column and foreign key column.

When an application reads a domain record from the First Tables, it also reads the extensions for each First Table from the Second Table by machining the primary key value of each First record and First Table name in the Second Table's foreign key column and PATH column, then determines whether an extension is for additional field of this First Table or extending the defined field of this First Table. Accordingly, the application constructs a domain message with the retrieved extensions and send the message back to the application that requests as a response. When an application persists a domain message to First Tables, it also needs to read each extension from the message for each extended defined field or for each additional field of a First Table and persist it into the Second Table, and adds an Extension Definition to the Third Table if the Extension Definition does not exist in the Third Table whereas the Extension Definition shall be included in the message.

This invention includes embodiments of A database system comprising a domain or standard defined data model comprising a collection of primitive and/or complex data types, and child data objects; one or more relational tables based on the domain or standard defined data model, wherein each of the tables has a set of fields and a primary key or a unique composite key, each field is a primitive data type, a complex data type, or a child data object, wherein some or all of the records have one or more extensions that either redefine the default content of one or more fields or add one or more additional fields to the records or the relational tables; a data structure constructed using foreign keys to represent a hierarchical relationship of the relational tables; one or more extension definition tables storing the definition of the extensions; and one or more extension tables identifying the record(s) of the one or more relational tables that have extension(s) and a reference to the records in the extension definition table that stores the extension(s) of each extended field. In the said database system, an extension definition table and an extension table can be combined into one table, becoming one and the same table. Furthermore, a complex data type can be a relational table that is associated with one or more other relational tables, and there can be a second level of extension table and extension definition table that define extension(s) of an extended field.

### BRIEF DESCRIPTION OF DRAWINGS

The present invention is disclosed in the following detailed description and the accompanying drawings.

FIG. 1 delineates an enterprise system of a standard defined domain relational database interacting with multiple enterprise applications.

FIG. 2 delineates standard defined domain relational tables metadata with the definitions of First Tables, Second Table and Third Table in a database system.

FIG. 3 delineates an example of standard defined domain relational tables with First Tables, Second Table, and Third Table according to the metadata of First Tables, Second Table, and Third Table of FIG. 2.

FIG. 4 delineates complex type table metadata appending to standard defined domain relational tables metadata of FIG. 2.

FIG. 5 delineates an example of complex type First Table with defined domain relational tables according to complex type metadata of FIG. 4.

FIG. 6 delineates the data flow diagram of persisting extensions for extending the defined fields or adding the additional fields to the primary First Table and the Second Table.

FIG. 7 delineates the data flow diagram of persisting extensions for extending the defined fields or adding the additional fields to the child or complex type First Tables and the Second Table.

FIG. 8 delineates the data flow diagram of retrieving extensions of the First Tables and the Second Table for extended and additional fields.

### DETAILED DESCRIPTION

Reference may now be made to the drawings wherein like numerals refer to like parts throughout. Exemplary embodiments of the invention may now be described. The exemplary embodiments are provided to illustrate aspects of the invention and should not be construed as limiting the scope of the invention. When the exemplary embodiments are described with reference to block diagrams or flowcharts, each block may represent a method step or an apparatus or system element for performing the method step. Depending upon the implementation, the corresponding apparatus element may be configured in hardware, software, firmware or combinations thereof.

The present invention can be implemented in numerous database systems, including RDBMS database systems, and/or any big data or NoSQL database platforms supporting relational models.

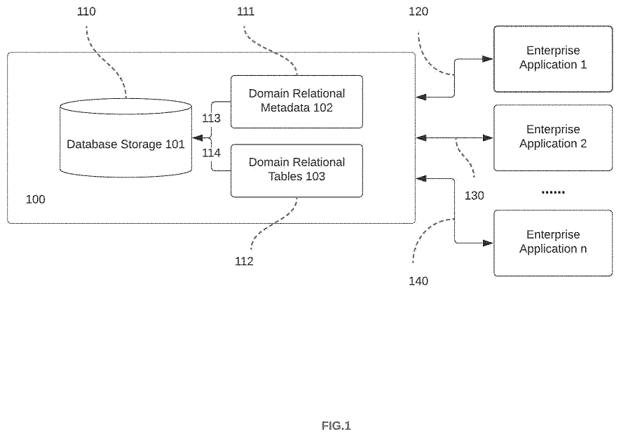

FIG. 1 illustrates a distributed enterprise system 100 comprising a standard relational database system 101, domain relational tables 103 defined by domain relational tables metadata 102 based on standard domain data models. Domain relational table metadata 102 and domain relational tables 103 are stored in the database system. A plurality of enterprise applications interacts with the database system through industry standard interfaces, where enterprise application 1 interacts with the database system using interface 120, enterprise application 2 interacts with the database system using interface 130, and enterprise application n interacts with the database system using interface 140. Each interface can leverage distinct industrial technology and approach. The standard defined domain data models are generally agreed industry or community common models across systems and organizations, covering a wide range of their needs. Enterprise applications may run within the same organization or across multiple organizations. An enterprise application can be cloud based or on-premise, centralized or distributed. Due to the diversity of the application requirements of the various organizations, each organization may have specific requirements that are not part of the standard defined domain data models. Each application may need to add different additional fields to the standard defined domain data models and may need to extend the meanings of the defined fields of the standard defined domain data models, and sometime do it on the fly as the need arises. Any extension added by one enterprise application can be available and understandable to other enterprise applications. In a large scale connected industry environment or community, the number and variety of applications can be very large, requiring a large variety of domain relational tables. Accordingly, standard defined domain relational tables expediate the deployment process, and the extensibility of the standard defined domain relational tables accommodates customization and simplifies the complexity of integration and interoperability further.

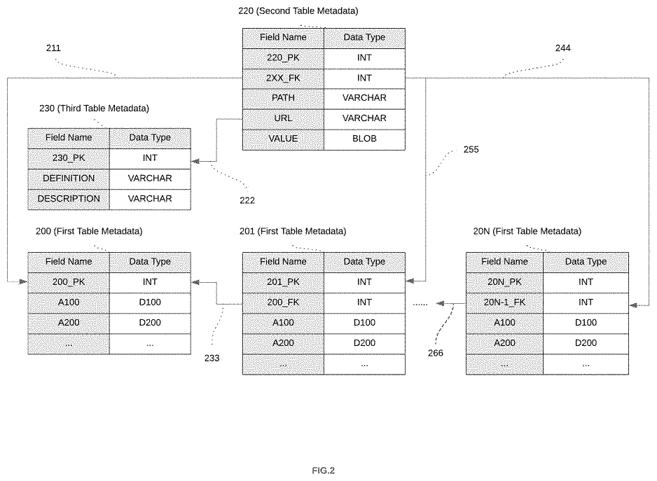

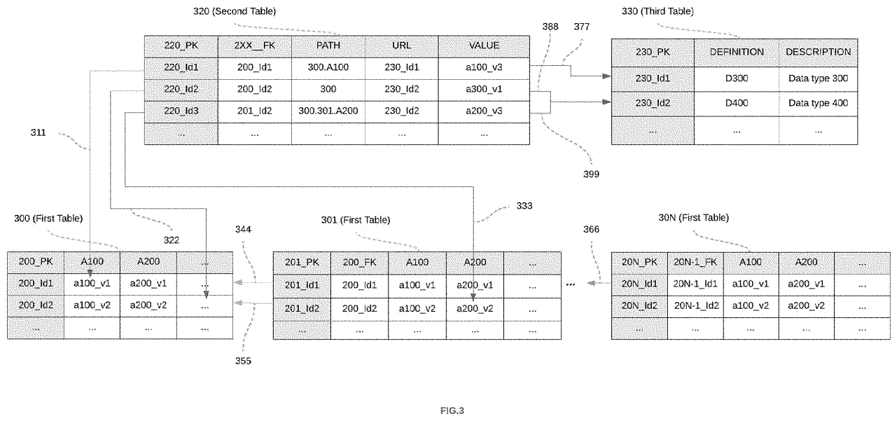

In standard defined domain data models, each domain has a primary object, a primary object can have one or more child objects, a child object can have one or more sub-child objects, and one parent object. A complex data type is a specific child object and can have one or more parent child objects. Primary object, child object, and complex data type are First Tables. FIG. 2 illustrates an example of standard defined domain relational tables metadata. Table 200 is the metadata of a primary First Table 300 in FIG. 3, and each row of 200 defines a column of the primary First Table 300 in FIG. 3, e.g., 200_PK in the Field Name column of 200 defines primary key column 200_PK of 300 in FIG. 3; A100 in the Field Name column defines the First field column A100 of 300 in FIG. 3, its data type is D100; and A200 in the Field Name column defines the First field column A200 of 300 in FIG. 3, its data type is D200. 200_PK is the primary key column of the First Table 300 in FIG. 3 that is a unique identifier of a record; normally it is integer data type. Both data types D100 and D200 are primitive data types that the underlying database system supports. Table 201 is metadata of the First Table 301 in FIG. 3 wherein 200_FK in the Field Name column of Table 201 defines the foreign key column 200_FK of 301 in FIG. 3 which links to the primary key column 200_PK of 300 that is defined by 200_PK in the Field Name column of Table 200, as illustrated in FIG. 2 by the arrow line 233. A100 and A200 in the Field Name column define the First field columns A100 and A200 of 301 in FIG. 3. A100's data type is defined as D100 in the Data Type column of 201; A200's data type is defined as D200 in the Data Type column of 20. Equivalently, Table 20N is metadata of the First Table 30N in FIG. 3. First Table 20N associates with its parent First Table using its foreign key 20N−1_FK, as illustrated in FIG. 2 by the arrow line 233

Table 220 is the metadata defining a Second Table 320 in FIG. 3. The Second table is an Extension Table which stores extension information. Table 220 metadata may contain the definition of the following columns of a Second Table 320 in FIG. 3: the primary key column 220_PK, the foreign key column 2XX_FK, PATH, URL and VALUE wherein the VALUE column retains actual data value of the extension and can refer to any data type that the underlying database supports based on the definition of the extension. Generically, VALUE stores the value in BLOB (Binary Large Object) or CLOB (Character Large Object) or VARCHAR (Variable Length Characters) data type, it can be serialized to or deserialized from any value of data type. The URL column points to the entry of the Third Table 330 in FIG. 3 that the definition of the extension is saved. The foreign key column 2XX_FK refers to any of the First Tables' primary keys, as illustrated in FIG. 2 by arrow lines 211, 244 and 255. Coming with column PATH and the foreign key column 2XX_FK determines which First Table the foreign key column 2XX_FK refers to. The PATH column represents hierarchical data structure and can comprise a sequence of primary object name, child object names, and field name of the data structure separated by a delimiter, usually, a dot “.”. The root of a path always represents primary object. The name element that is the farthest from the root can be a field name or an object name; if it is an object name, it indicates that the extension is the additional field for that object in the First Table; if it is a field name, it indicates that the extension is the extended field for the defined field of that object in the First Table identified by the element name that is the second farthest from the root. The expression of the path is formed below:

PATH=[Name of Primary Object First Table] {.[Name of Child Object First Table]*}{.[Field Name of Primary Object or Child Object]}? Where ‘*’ indicates occurrence of zero or more times; ‘?’ occurrence of zero or one time.

For example,

| No | PATH | PATH MEANING |
|---|---|---|
| 1 | PATH = 300 | Extension is additional field to the |
| | | First Table 300 in FIG. 3 |
| 2 | PATH = 300.A100 | Extension is the extended meaning of |
| | | field A100 of the First Table 300 |
| 3 | PATH = 300.301 | Extension is the additional field |
| | | to the First Table 301 In FIG. 3, 300 |
| | | is the parent of 301. |
| 4 | PATH = 300.301.A200 | Extension is the extended meaning |
| | | of field A200 of the First Table 301 |
| | | in FIG. 3 |

Table 230 in FIG. 2 is the metadata defining a Third Table 330 in FIG. 3. The Third Table is an Extension Definition Table (EDT) which stores Extension Definitions. The EDT may comprise the columns of primary key 230_PK, DEFINITION, and DESCRIPTION. Both DEFINITION and DESCRIPTION columns are a data type of VARCHAR (variable length characters). DEFINITION includes the metadata of extension and the meaning of the extension. The format is generally agreed and understandable by all enterprise applications, e.g., JSON format or XML format or DSL (Domain-Specific Language) or a reference or a Pointer to the Fourth Table (Field Definition Table). The metadata of DEFINITION may include Field Name, Data Type, Size, Minimum Value, Maximum Value, Description, Constraints, User-defined Attributes, and others. The column URL of the Second Table 320 of FIG. 3 points to the primary key column 230_PK of the Third Table 330 of FIG. 3, as illustrated in FIG. 2 by arrow lines 222. The entries of the Third Table 330 in FIG. 3 can be prepopulated using an industrial standard interface or can be persisted through the incoming message of enterprise applications on the fly.

FIG. 3 illustrates an example of domain relational tables with First Tables, Second Table, and Third Table according to the metadata of the First Tables, Second Table, and Third Table in FIG. 2. The First Tables 300, 301, and 30N store the relational value records. The Second Table 320 stores each extension instance of the First Tables, the Third Table 330 stores the meaning of each extension of the Second Table 320. As shown in FIG. 3, the First Table 300 has two records identified by its primary key values 200_Id1 and 200_Id2 in the primary key 200_PK column. The record 200_Id1 has two fields' values a100_v1 and a200_v1; wherein the record 200_Id1 of the First Table 300 is associated with the record 201_Id1 of the First Table 301; The record 201_Id1 in the First Table 301 contains two fields' values a100_v1 and a200_v1. The record 200_Id2 of the First Table 300 has two fields' values a100_v2 and a200_v2; wherein the record 200_Id2 of the First Table 300 is associated with the record 201_Id2 of the First Table 301; The record 201_Id2 in the First Table 301 contains two fields' values a100_v2 and a200_v2.

In the first row of the Second Table 320, the record 220_Id1 has a PATH 300.A100 that indicates that the field A100 of the First Table 300 is an extended field and denotes that its foreign key 2XX_FK value 200_Id1 associates with the record 200_Id1 in the first row of the First Table 300. Accordingly, the new value of the field A100 of the record 200_Id1 of the First Table 300 is a100_v3, the explanation of this value is defined by the record 230_Id1 in the first row of the Third Table 330 by referring its URL value.

In the second row of the Second Table 320, the second record 220_Id2 contains a PATH 300 that indicates that the First Table 300 has an additional field, also and denotes that its foreign key 2XX_FK value 200_Id2 connects to the record 200_Id2 of the second row of the First Table 300. Consequently, the value of the new field is a300_v1 and its field name and data type are defined by the record 230_Id2 of the second row in the Third Table 330 by referring its URL value 230_Id2.

In the third row of the Second Table 320, the record 220_Id3 of the Second Table 320 has a PATH value 300.301.A200 that indicates the field A200 of the First Table 301 is an extended field and denotes that its foreign key 2XX_FK value 201_Id2 points to the record 201_Id2 of the second row in the First Table 301. As a result, the new value of the field A200 of the First Table 301's record 201_Id2 is a200_v3, the explanation of this value is defined by the record 230_Id2 in the second row of the Third Table 330 by referring its URL value. Two extensions 220_Id2 and 220_Id3 in the Second Table 320 refer to the same Extension Definition in the Third Table 330.

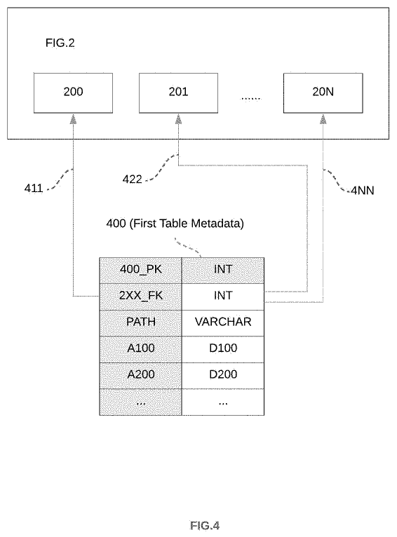

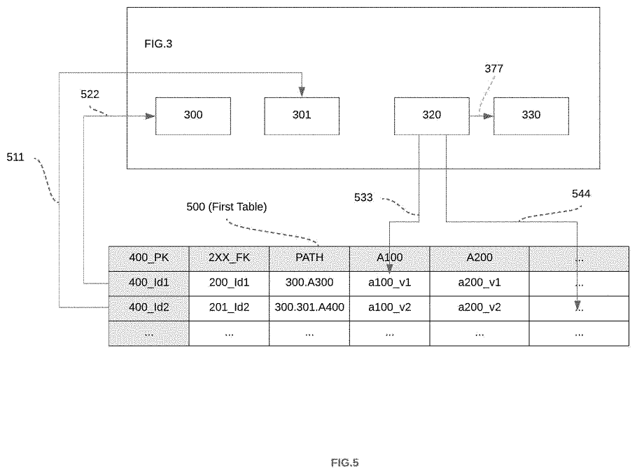

FIG. 4 is a complex data type metadata diagram extending domain relational tables metadata of FIG. 2 by adding complex data type. A complex type table metadata 400 defines a First Table 500 as shown in FIG. 5 and consists of multiple columns, e.g., primary key column 400_PK, the foreign key column 2XX_FK, PATH, and one or more field columns such as A100 and A200 fields. 400_PK is the primary key column of the First Table 400 that is a unique identifier of a record; normally it is an integer data type. The field A100 of the First Table 400 is D100 data type, and the field A200 of the First Table 400 is D200 data type. Both D100 and D200 of the First Table 400 are primitive data types of the database system. Every First Table may associate with one or more complex type tables. A First Table associates a complex type table using its foreign key 2XX_FK. 2XX_FK can be any other First Table's primary key. PATH represents which First Table associates with the complex type table 400 and what First field name is. PATH comprises a First Table name and a First field name of a First Table separated by a delimiter, usually, a dot “.”. The root of a path always represents a First Table. The expression of the path is formed below:

PATH=[Name of First Table]. [Name of Field]

For example,

| No | PATH | PATH MEANING |
|---|---|---|
| 1 | PATH = 300.A300 | Field A300 of the First Table 300 is a |
| | | complex data type which is defined by this |
| | | record of 400 |

2 PATH=300.301.A300Field A300 of the First Table 301 is a complex data type which is defined by this record of 400, 301 associates with 300.

A primary object and child objects may have one or more distinct complex data type objects based on the standard defined domain models, a complex data type object could contain one or more other complex data types. That is, a primary First Table and child First Tables can be associated with one or more complex type First Tables. A complex type First Table also can be extended by redefining the meanings of defined fields or adding additional fields.

FIG. 5 illustrates an example of a complex type First Table with primary and child First Tables according to complex data type metadata in FIG. 4. As shown, the complex type First Table 500 contains one or more records, e.g., two records are identified respectively by the primary key value 400_Id1 and 400_Id2. By referring to its PATH value 300.A300 and foreign key column 2XX_FK value 200_Id1, the record 400_Id1 in the first row associates with the record 200_Id1 of the First Table 300; the complex type field name of the First Table 300 is A300; In the first row of 500, A100 and A200 of the record 400_Id1 have values a100_v1 and a200_v1; By referring to the Second Table 320 and using the same approach addressed in FIG. 3, the arrow line 533 indicates that the field A100 of the record 400_Id1 is extended, its new value refers to the Second Table; By referring to PATH 300.301.A400 in the second row of 500, the arrow line 544 indicates that the record 400_Id2 adds a new field A300, the new field detail about the data type, the usage, and description refers to the Second Table 320.

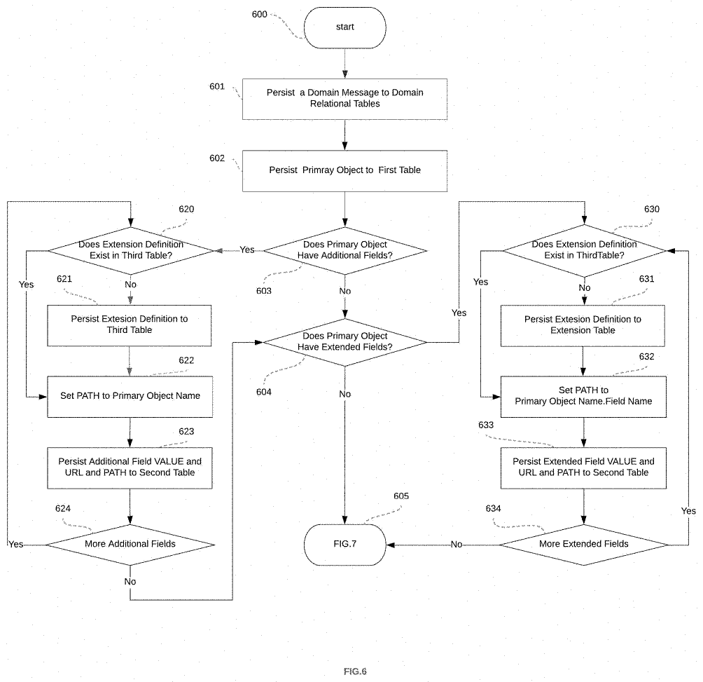

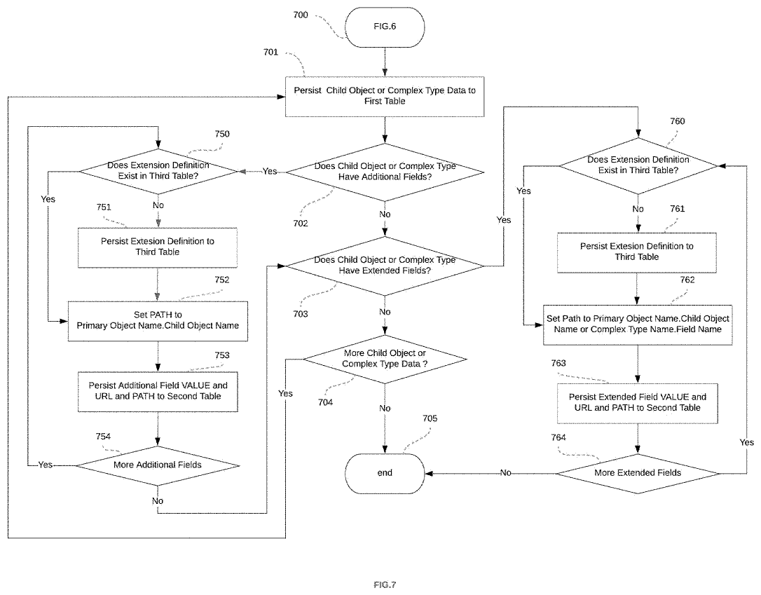

FIG. 6 is the first part of a data flow block diagram illustrating how to persist various kinds of extensions along with a domain message. In FIG. 6, the data flow exhibits how to process a primary object's extensions. Process 601 initiates to persist a domain message to domain relational tables illustrated in FIG. 2 and FIG. 3. Process 602 persists the primary object to the First Table 300 in FIG. 3. Block 603 processes the primary object to determine whether it contains additional fields; if yes, 603 goes to block 620; otherwise goes to decision block 604. For each additional field of the primary object, block 620 checks whether the Extension Definition of the field is in the Third Table 330 as addressed in FIG. 3 using URL; if yes, the processing goes from 620 to block 622; if not, it indicates that is a new Extension Definition, the process 621 persists the new Extension Definition to the Third Table 330 of FIG. 3. The process 622 creates the PATH value by setting the primary First Table name to PATH: e.g., PATH=300. And the process 623 persists additional field VALUE, URL and PATH along with the primary key of the primary First Record to the Second Table 320 of FIG. 3. In block 624, it is determined whether the primary object has more additional field; if yes, 624 goes back to 620 for reiteration; otherwise the processing moves to the next step 604. In step 604, it is determined whether the primary object contains any extended fields; if 604 returns no, the processing moves to the next step 605 for further processing, see FIG. 7. Otherwise, the processing goes to step 630.

For each extended field of the primary object, the decision process 630 in FIG. 6 evaluates, using the URL field, whether the Third Table 330 as shown in FIG. 3 has its the Extension Definition of the field; if the evaluation result is yes, the processing goes from 630 to 632; if the evaluation result is no, it indicates that is a new Extension Definition, the process 631 persists the new Extension Definition in the Third Table 330 of FIG. 3; Process 632 creates PATH value by setting the primary First Table name and the extended field name to PATH: e.g., PATH=300.A100, wherein A100 is the defined field name of the primary First Table 300 as shown in FIG. 3. The process 633 persists the extended field VALUE, URL and PATH along with the primary key of the primary First record to the Second Table 320 as shown in FIG. 3. In block 634, it is determined whether there are more extended fields in primary object; if the result is yes, it goes back to 630 for reiteration; otherwise the processing moves to the next step 605 for further processing described in FIG. 7.

FIG. 7 is the second part of a processing block diagram illustrating how to persist various kinds of extensions along with a domain message. FIG. 7 shows how to process child objects' and complex data types' extensions. Process 701 initiates to persist child object and complex data type's data to domain relational tables that are addressed in FIG. 3 and FIG. 5. Step 702 tests whether a child object or complex data type value contains additional field(s); if yes, the processing goes to 750, otherwise to 703. For an extension of each additional field of the child object and complex data types, step 750 determines whether the extension definition of the field has an entry in the extension definition Third Table 330 as addressed in FIG. 3 using the URL; if yes, the processing goes from 750 to 752; if not, it indicates a new extension definition, process 751 persists the new extension definition in the Third Table 300; Process 752 creates the PATH value by setting the primary First Table name and child object name or complex data type name to PATH, e.g.,

PATH=300. 301

PATH=300.301.500

wherein 1) 300.301 indicates that the extension is an additional field of the child First Table 301 of its parent First Table 300 in FIG. 3; 2) 300.301.500 indicates that the extension is an additional field of the complex type First Table 500 in FIG. 5 of its parent First Table 301 in FIG. 3. Process 753 persists additional field VALUE, URL and PATH along with the child object or complex data type primary key of the primary first record to the Second Table 320. Step 754 determines whether there are more additional fields in child object and complex data type object; if yes, 754 goes back to 750 for reiteration; otherwise the processing moves to the next step 703.

Step 703 tests whether the child object or complex data type object contains any extended fields; if not, the processing moves to 704; otherwise it moves to 760; Step 704 determines whether the primary object contains more child objects and complex data type objects; if it has more child objects or complex data type data, the processing moves back to 701 for reiteration; otherwise the processing goes to 705 and the domain message process finishes.

Step 760 determines whether the extension definition of the extended field has an entry in the extension definition Third Table 330 as addressed in FIG. 3 using the URL; if yes, the processing goes from 760 to 762; if not, it indicates a new extension definition, process 761 persists the new extension definition in the Third Table 330 as shown FIG. 3. Process 762 creates PATH value by setting the primary First Table name, child object name or complex data type name and extended field name to PATH: e.g.,

PATH=300. 301.A100

PATH=300. 400.A200

PATH=300. 301.400.A300

wherein 1) A100 is the extended field of the First Table 301 of its parent First Table 300 in FIG. 3; 2) A200 is the extended field of the complex type First Table 500 in FIG. 5 wherein the parent First Table of 500 is 300 in FIG. 3; 3) A300 is the extended field of the complex type First Table 500 of the parent First Table 301 in FIG. 3. Process 763 persists additional field VALUE, URL and PATH along with the child object or complex type and the primary key of the primary First record of the child or complex type First Table to the Second Table 320 as shown in FIG. 3. Lastly, step 764 tests whether there are more extended fields in child object and complex data type object; if yes, the processing goes back to 760 for reiteration; otherwise the processing moves to 705 and finishes.

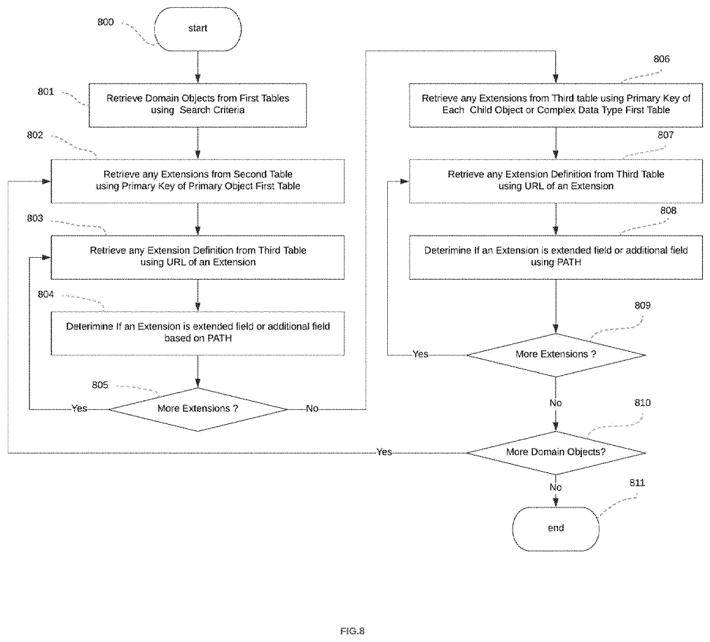

FIG. 8 is a processing block diagram illustrating how to retrieve various kinds of extensions along with a domain message. 801 starts with reading domain records from First Tables according to user defined search criteria. Then for each domain record, step 802 retrieves any extensions form the Second Table 301 (Extension Table) in FIG. 3 using the primary key of the primary First record. For each retrieved extension, step 803 retrieves an Extension Definition from the Third Table 330 (Extension Definition Table); step 804 determines whether the extension is extended field or additional field of the primary object using PATH: e.g.,

PATH=300

PATH=300.A100

wherein 1) PATH=300 indicates that the extension is an additional field of the primary First Table 300 in FIG. 3; 2) PATH=300.A100 indicates that the extension is an extended field A100 of the primary First Table 300 in FIG. 3.

Step 805 determines whether there are more extensions. If there is no more retrieved extension, the processing moves to the next step 806; Otherwise, it goes back to 803 for iteration. Step 806 retrieves any extensions from the Second Table 320 (Extension Table) shown in FIG. 3 using the primary key of each child First Record of the child First Table or the complex type First Table. For each retrieved extension, step 807 retrieves an Extension Definition from the Third Table 330 (Extension Definition Table), and step 808 determines whether the extension is extended field or additional field of the child or complex type First Table using PATH, e.g.,

PATH=300.301

PATH=300.301.A100

PATH=300.500

PATH=300.500.A200

wherein 1) PATH=300.301 indicates that the extension is the additional field of the First Table 301 of its parent First Table 301 in FIG. 3; 2) PATH=300.301.A100 indicates that the extension is the extended field A100 of the First Table 301 of its parent First Table 301 in FIG. 3; 3) PATH=300.500 indicates that the extension is the additional field of the complex type First Table 500 in FIG. 5 of its parent First Table 300 in FIG. 3; and 4) PATH=300.500.A200 indicates that the extension is the extended field A200 of the First Table 500 of its parent First Table 300.

Step 809 determines whether there are more extensions. If there is no more retrieved extension, the processing moves to 810; otherwise to 807 for more reiterations. Step 810 tests whether there are more retrieved domain records, if there are more, the processing goes back to 802 to process more domain records; otherwise, the processing ends.

The above examples show elements of this invention. They can be further generalized by adding more fields and tables, combining fields and tables, combining or using multilayer pointers or links, embedding another hierarchy of data model into a standard defined data model etc. The methods and systems for extending a relational database disclosed therefore comprise creating one or more First Tables, each of which comprising a unique table ID, multiple first records and each first record comprising a primary key, and one or more first fields, and some or all the first fields have one or more extension which redefines the meaning and/or data type of the first field(s) that are different from the default or standard defined meaning and/or data type of the first field(s); creating one or more Second Tables with one or more records each of which has one or more Path field(s) that stores the table ID, field ID and the primary key to identify a first record that has a first field with an extension, and a Value field that stores the value of the extended data type of the first field if the extension defines a different data type from the default data type and/or a meaning field that defines the meaning of the first field if the first field has an extended meaning; and retrieving a first field that has an extension comprising using one or more Path field(s) in a Second Table to identify the first field, retrieving the value of the first field from the Value field in a Second Table if the first field has an extended data type, or retrieving the meaning of the first field from the meaning field in the Second Table if the first field has an extended meaning.

Furthermore, a meaning field can be a Pointer field that points to a record in a Third Table; and one or more Third Tables with one or more records can be created wherein each record stores the meaning(s) of the extension(s) of the first field(s) identified by the one or more Path fields in a Second Table; and retrieving the meaning of a first field that has an extension comprising using one or more Path fields in a Second Table to identify the first field, and retrieving the corresponding Pointer in the Second Table and using the said Pointer to retrieve the meaning of the first field from a Third Table referenced by the said Pointer.

The steps for updating or writing a record or an extended field is similar, involving updating or writing in a Second Table, and a Third Table if a separate Table is used, the Path, Value and meaning field for a first field in a First Table, e.g., updating a first field with an extension comprises using one or more Path field(s) in a Second Table to identify the first field, and updating the value of the extended first field in the Value field in the Second Table. A Second Table and a Third Table can also be combined into one table, therefore becoming one and the same. In some cases, one Second Table will suffice, but in other cases when one Second Table becomes too large, it may be split into multiple Second Tables to improve the performance. In addition, a second level of Second Table and Third Table can be used to add a second level of extended field(s) to an extended first field defined in the Second Table and Third Table.

The methods and systems for extending a relational database disclosed also comprise creating one or more First Tables, each of which comprising a unique table ID, multiple first records and each first record comprising a primary key, and one or more first fields, and some or all of the first records of the one or more First Tables are extended by adding one or more additional first fields, and the additional first field(s) are not stored in the first record(s); creating one or more Second Tables with one or more records each of which has one or more Path field(s) that stores the table ID and the primary key to identify a first record that is extended to have one or more additional fields, one or more Value fields each of which stores the value of an additional first field of the first record, and a meaning field that defines the meaning of the additional first field; and retrieving an additional first field of a first record comprising using one or more Path fields in a Second Table to identify the first record, retrieving the value of the additional first field from the Value field in the Second Table, and the meaning of the additional first field from the meaning field in the Second Table.

Furthermore, a meaning field can be a Pointer field that points to a record in a Third Table; and one or more Third Tables of one or more records can be created wherein each record stores the meaning of the additional first field(s) of the first record identified by the one or more Path fields in the Second Table; and retrieving the meaning of an additional first field of a first record comprising using one or more Path fields in a Second Table to identify the first record, and retrieving the corresponding Pointer in the Second Table and using the said Pointer to retrieve the meaning of the additional first field from a Third Table referenced by the said Pointer.

The steps for updating or writing a record or an additional field is similar, involving updating or writing in a Second Table, and a Third Table if a separate Table is used, the Path, Value and meaning field for a first field in a First Table, e.g., updating a first record extended by an additional first field comprises using one or more Path fields in a Second Table to identify the first record, and updating the value of the additional first field of the first record in the Value field in the Second Table.

A Second Table and a Third Table can also be combined into one table. In some cases, one Second Table will suffice, but in other cases when one Second Table becomes too large, it may be split into multiple Second Tables to improve the performance. In addition, a second level of Second Table and Third Table can be used to add a second level of additional field(s) to an additional first field defined in the Second Table and Third Table.

Although the foregoing descriptions of the preferred embodiments of the present inventions have shown, described, or illustrated the fundamental novel features or principles of the inventions, it is understood that various omissions, substitutions, and changes in the form of the detail of the methods, elements or apparatuses as illustrated, as well as the uses thereof, may be made by those skilled in the art without departing from the spirit of the present inventions. Hence, the scope of the present inventions should not be limited to the foregoing descriptions. Rather, the principles of the inventions may be applied to a wide range of methods, systems, and apparatuses, to achieve the advantages described herein and to achieve other advantages or to satisfy other objectives as well.

We claim:

1. A database system comprising
a domain or standard defined data model comprising a collection of primitive and/or complex data types, and child data objects;
one or more relational tables based on the domain or standard defined data model, wherein each of the tables has a set of fields and a primary key or a unique composite key, each field is a primitive data type, a complex data type, or a child data object, wherein some or all of the records have one or more extensions that either redefine the default content of one or more fields or add one or more additional fields to the records or the relational tables;
a data structure constructed using foreign keys to represent a hierarchical relationship of the relational tables;
one or more extension definition tables storing the definition of the extensions; and
one or more extension tables identifying the record(s) of the one or more relational tables that have extension(s) and a reference to the records in the extension definition table that stores the extension(s) of each extended field.

2. The database system of claim 1 wherein an extension definition table and an extension table are combined into one table.

3. The database system of claim 1 wherein a complex data type is a relational table that is associated with one or more other relational tables.

4. The database system of claim 1 further comprising a second level of extension table and extension definition table that define extension(s) of an extended field.

5. A method for extending a relational database comprising
creating one or more First Tables, each of which comprising a unique table ID, multiple first records and each first record comprising a primary key, and one or more first fields, and some or all the first fields have one or more extension which redefines the meaning and/or data type of the first field(s) that are different from the default or standard defined meaning and/or data type of the first field(s);
creating one or more Second Tables with one or more records each of which has one or more Path field(s) that stores the table ID, field ID and the primary key to identify a first record that has a first field with an extension, and a Value field that stores the value of the extended data type of the first field if the extension defines a different data type from the default data type and/or a meaning field that defines the meaning of the first field if the first field has an extended meaning; and
retrieving a first field that has an extension comprising using one or more Path field(s) in a Second Table to identify the first field, retrieving the value of the first field from the Value field in the Second Table if the first field has an extended data type, or retrieving the meaning of the first field from the meaning field in the Second Table if the first field has an extended meaning.

6. The method of claim 5 further comprising updating a first field with an extension comprising using one or more Path field(s) in a Second Table to identify the first field, and updating the value of the extended first field in the Value field in the Second Table.

7. The method of claim 5 wherein a meaning field is a Pointer field that points to a record in a Third Table; and further comprising
creating one or more Third Tables with one or more records to store the meaning(s) of the extension(s) of the first field(s) identified by the one or more Path fields in a Second Table; and
retrieving the meaning of a first field that has an extension comprising using one or more Path fields in a Second Table to identify the first field, and retrieving the corresponding Pointer in the Second Table and using the said Pointer to retrieve the meaning of the first field from a Third Table referenced by the said Pointer.

8. The method of claim 7 wherein a Second Table and a Third Table are combined into one table.

9. The method of claim 7 further comprising using a second level of Second Table and Third Table that add a second level of extended field(s) to an extended first field defined in the Second Table and Third Table.

10. A method for extending a relational database comprising
creating one or more First Tables, each of which comprising a unique table ID, multiple first records and each first record comprising a primary key, and one or more first fields, and some or all of the first records of the one or more First Tables are extended by adding one or more additional first fields, and the additional first field(s) are not stored in the first record(s);
creating one or more Second Tables with one or more records each of which has one or more Path field(s) that stores the table ID and the primary key to identify a first record that is extended to have one or more additional fields, one or more Value fields each of which stores the value of an additional first field of the first record, and a meaning field that defines the meaning of the additional first field; and
retrieving an additional first field of a first record comprising using one or more Path fields in a Second Table to identify the first record, retrieving the value of the additional first field from the Value field in the Second Table, and the meaning of the additional first field from the meaning field in the Second Table.

11. The method of claim 10 further comprising updating a first record extended by an additional first field comprising using one or more Path fields in a Second Table to identify the first record, and updating the value of the additional first field of the first record in the Value field in the Second Table.

12. The method of claim 10 wherein a meaning field is a Pointer field that points to a record in a Third Table; and further comprising
creating one or more Third Tables of one or more records each of which stores the meaning of the additional first field(s) of the first record identified by the one or more Path fields in the Second Table; and
retrieving the meaning of an additional first field of a first record comprising using one or more Path fields in a Second Table to identify the first record, and retrieving the corresponding Pointer in the Second Table and using the said Pointer to retrieve the meaning of the additional first field from a Third Table referenced by the said Pointer.

13. The method of claim 12 wherein a Second Table and a Third Table are combined into one table.

14. The method of claim 12 further comprising using a second level of Second Table and Third Table that add a second level of additional field(s) to an additional first field defined in the Second Table and Third Table.
